(19) United States
(12) Patent Application Publication
(10) Pub. No.: US 2024/0351158 A1
(43) Pub. Date: Oct. 24, 2024

(54) Elastic Membrane for a Retainer for the Processing of Optical Workpieces, Particularly Spectacle Lenses, and Retainer Equipped Therewith

(71) Applicant: Satisloh AG, Baar (CH)

(72) Inventors: Holger Schäfer, Weilmünster (DE); Martin Lautz, Nauborn (DE); Johannes Claar, Ebsdorfergrund (DE)

(21) Appl. No.: 18/638,323

(22) Filed: Apr. 17, 2024

(30) Foreign Application Priority Data
Apr. 20, 2023 (DE) 10 2023 110 129.3

(51) Int. Cl. B24B 13/005; B25B 11/00

(52) U.S. Cl. CPC B24B 13/005; B25B 11/005

(57) ABSTRACT

An elastic membrane for a retainer for the processing of optical workpieces is constructed with a securing section for mounting on a housing of the retainer, so as to bound therein a chamber by a retaining section which is connected with the securing section. The retaining section has an outer side, on which a workpiece can be placed over an area by a workpiece surface, and an inner side, which is constructed to contact a support arrangement, for the workpiece. The retaining section has a perforation with at least one opening connecting the inner side and outer side and by way of which a vacuum applied to the chamber can be conducted to the outer side. Associated with the opening is a semi-permeable, functional membrane which extends merely locally in a region directly adjoining the opening.

### TECHNICAL FIELD

The present invention relates generally to an elastic membrane for a retainer for the processing of optical workpieces and to a retainer equipped therewith. In particular, the invention relates to an elastic membrane for a retainer for the processing of spectacle lenses, preferably spectacle lenses of plastic such as, for example, polycarbonate, CR39 or so-called “high index” materials, but in principle also for spectacle lenses of hard brittle materials such as, for example, mineral glass. Spectacle lenses of that kind are produced on a large scale in so-called “RX workshops”, i.e. production facilities for production of individual spectacle lenses according to prescription.

The elastic membrane described herein develops the elastic membrane, which is described in (inter alia) earlier German Patent Application DE 10 2021 005 202.1 (DE 10 2021 005 202 A1) of the same applicant, for a retainer for the processing of, in particular, spectacle lenses and is very well suited for use in, for example, a method for (area) processing by machining of, in particular, spectacle lenses of plastic, such as described in document DE 10 2021 004 831 A1. In addition, specific use can be made of the elastic membrane described herein at a “retainer for the processing of optical workpieces, particularly spectacle lenses” such as is the subject of German Patent Application DE 10 2023 110 130.7, filed at the same time under this title, of the same applicant. Express reference is made at this point to the afore-mentioned documents (DE 10 2021 005 202 A1, DE 10 2021 004 831 A1, DE 10 2023 110 130.7) with respect to structural details of the retainer as well as use and method details.

### PRIOR ART

In the above-mentioned document DE 10 2021 004 831 A1 there has already been detailed description of those process steps which currently are usually performed in RX workshops in the industrial production of spectacle lenses, so that the usual procedure need be only briefly outlined at this point. The starting product in industrial production of spectacle lenses is a semi-finished spectacle lens blank, also termed “blank”, which has one optically effective surface already processed to finished state and provided by injection molding or preshaped in some other way and which is to be processed at its other optically effective surface and at the edge between the optically effective surfaces to form a finished spectacle lens.

After protection of the pre-shaped optically effective surface by a protective film or a protective lacquer so-called “blocking” of the respective spectacle lens blank is carried out, which in that case is connected with a suitable so-called “block piece”, for example a block piece in accordance with German Standard DIN 58766. For the blocking, firstly position and optionally shape of the spectacle lens blank are determined by measurement before the spectacle lens blank is then positioned in six degrees of freedom relative to the block piece so that the block piece adopts a predetermined position relative to the protected, preshaped surface of the spectacle lens blank. Fixing of this set position takes place subsequently by filling the space between block piece and spectacle lens blank with a conventional molten material (“alloy” or wax; see, for example, EP 1 593 458 A2) or alternatively by a suitable thermoplastic, thermosetting or elastomeric plastic or adhesive (see, for example, DE 10 2007 007 161 A1, EP 2 011 604 A1, WO 2009/135689 A1). After solidifying or hardening of the filler material the block piece represents a mount or machine interface for the processing of the spectacle lens blank, which subsequently remains at the spectacle lens for several processing procedures in different machines so as to then be able to rotationally drive the spectacle lens and reliably hold it in an always defined position.

In the next step, i.e. the so-called “generation”, the hitherto not yet processed optically effective surface of the respective spectacle lens blank gains its macrogeometry, i.e. optically active shape in accordance with prescription, in a special processing machine, also called “generator” (see, for example, EP 1 719 585 A2, EP 2 011 603 A1), by (preliminary) processing by machining; in the case of plastic this is usually milling and/or turning with a geometrically defined cutting edge. In that case the blocked spectacle lens blank is held by the block piece at a rotationally driven workpiece spindle. The generation usually comprises at least two sub-steps (see, for example, EP 1 203 626 B1), namely preliminary edge processing, also called preliminary edging or “cribbing”, in which the edge of the spectacle lens blank is processed from the so-called “raw diameter” to the so-called “finished diameter”—in the case of plastic by, for example, a plate mill (cf., for example, EP 0 758 571 B1)—and a surface processing subsequent thereto. In the case of plastic the latter can begin by a (at least one) milling cycle over the surface, in accordance with which the main quantity of the blank material to be removed is already taken away, usually followed by an “out-of-round” rotary processing with the help of a so-called “fast tool” arrangement (see, for example, EP 1 779 967 A2) for the reciprocating drive of a diamond turning tool so as to (also) work non-rotationally symmetrical surface sections—for example freeform areas in varifocal lenses—at the semi-finished product. A precondition for the discussed preliminary edge processing by a mill is that the block piece temporarily mounted on the front side of the spectacle lens blank has a maximum diameter smaller than the finished diameter of the workpiece, since otherwise a collision between milling tool and block piece would occur.

Fine processing by (micro) machining, which is broadly termed “polishing”, of the spectacle lenses is then carried out, in which the pre-processed optically effective surface of the respective semi-finished product gains the desired microgeometry (surface quality), in particular by geometrically undefined cutting. For that purpose the blocked semi-finished product, which has been pre-processed by machining, is removed from the generator and further processed in a fine-processing or polishing machine (see, for example, EP 2 308 644 A2). In that case, positioning and fixing of the semi-finished product in the polishing machine also take place by the block piece (see, for example, EP 1 473 116 A1). During the polishing treatment there is movement—with addition of a liquid polishing agent provided with abrasive particles—by a flexible polishing tool or polishing plate (see, for example, EP 1 698 432 A2, WO 2016/058661 A1) in defined tracks over the pre-processed surface so as to reduce surface roughness.

Marking of the semi-finished product takes place as a next, optional process step, wherein, for example, two small circles are generated on the rear surface of the semi-finished product by, for example, a laser beam or mechanically by an engraving graver (see, for example, EP 1 916 060 B1). This is necessary for, for example, freeform surfaces so as to reliably find, by way of the applied markings, the position of the semi-finished product in later processing steps. Since a high degree of accuracy in positioning is required here, positioning and fixing during marking also take place by way of the block piece.

The semi-finished product is separated from the block piece only after this processing. The so-called “deblocking” takes place, for example, in the case of the afore-mentioned adhesive connection by a high-pressure water jet which is delivered by a nozzle and which impinges on an edge location between block piece and semi-finished product in order to detach the semi-finished product from the block piece by application of hydraulic forces (see, for example, WO 2011/042091 A1, WO 2011/107227 A1). As a consequence, the processed semi-finished product is now present as a single item and the separated block piece is cleaned and returned to the process step of blocking.

In further processing, the semi-finished product after cleaning is optionally coated at its front side and/or rear side in order to achieve additional effects: increase in scratch resistance by hard-coating, anti-reflection properties, coloration, metallization, hydrophobic properties, etc.

In conclusion, so-called “edging” is performed as a final process step, in which the semi-finished product is processed again at the edge for fitting into a desired spectacles frame, so that it receives the shape of the respective spectacles rim. Since the semi-finished product is now no longer fixed on the block piece, the position has to be re-established here (for example by way of the afore-mentioned markings) before the semi-finished product can be suitably fixed and finally processed in a so-called “edger” as an edge processing device (see, for example, EP 1 243 380 A2) with respect to its edge shape and fastening in the spectacles frame.

The process chain outlined in that regard from the prior art includes in the steps “blocking” and “deblocking” two sequences which represent necessary auxiliary processes, but do not themselves enhance the value of the produced spectacle lens. A process chain managing without these auxiliary processes would thus be desirable. In particular, in order to increase efficiency and also for ecological considerations it has already been proposed in the prior art to operate “blocklessly” in the production of optically effective surfaces of spectacle lenses, wherein the spectacle lenses are held by special holding devices or retainers during the processing (see, for example, documents WO 2015/059007 A1, U.S. Pat. No. 9,969,051 B2, DE 10 2016 112 999 A1 and DE 10 2004 016 445 B4).

As discussed in detail in earlier German Patent Application DE 10 2021 005 202.1 (DE 10 2021 005 202 A1) already mentioned in the introductory portion of the description, to which at this point reference may again be made, in the previously known holding devices or retainers there is, however, the risk that the spectacle lenses in or during processing experience undesired elastic deformations or deflections, whether as a consequence of unsupported cavities under the respective lens, into which the lens is deformed under the acting processing forces (WO 2015/059007 A1, U.S. Pat. No. 9,969,051 B2) or due to mechanical clamping at the circumferential edge of the respective lens by radially directed clamping forces (DE 10 2016 112 999 A1, DE 10 2004 016 445 B4). In the case of processing comparatively thin lenses this can lead to, in particular, unacceptable differences between the actual geometry produced at the rear surface and the target geometry desired thereat, which become noticeable when the lens after processing “relaxes” again. Such lens deformations detracting from processing quality and caused by the retention system are particularly critical when comparatively complex surface geometries, i.e. other than purely spherical or toroidal surfaces, are to be produced.

Against this background, in order to hold and support the workpiece during workpiece processing in a manner more reliable in terms of process and without workpiece deformations detracting from processing quality a special retainer for the processing of optical workpieces, particularly spectacle lenses, each with two workpiece surfaces and a workpiece edge therebetween is proposed in earlier German Patent Application DE 10 2021 005 202.1 (DE 10 2021 005 202 A1). This retainer comprises a holding arrangement for a workpiece to be processed as well as a support arrangement for the workpiece to be processed. In the embodiment disclosed here the support arrangement has a rubber-elastic membrane mounted on a housing and having a retaining section, on the outer side of which the workpiece can be laid over an area by one of its workpiece surfaces. The membrane together with the housing bounds a chamber in which a plurality of separate longitudinally displaceable pins of the support arrangement is accommodated, each of which pins can be brought by a pin end into contact with an inner side of the retaining section of the rubber-elastic membrane. In addition, these pins are selectively fixable to one another by a transversely acting clamping mechanism against longitudinal displacement with respect to the housing or can be blocked by an axially acting blocking mechanism, in order to firmly support the retaining section in accordance with a geometry of the workpiece held by the holding arrangement.

Furthermore, a special feature of the retainer in the embodiment disclosed in earlier German Patent Application DE 10 2021 005 202.1 (DE 10 2021 005 202 A1) is that the holding arrangement for the workpiece to be processed is provided in or at the retaining section of the rubber-elastic membrane and is capable of holding the workpiece without engaging the workpiece edge. For that purpose, in this solution in concrete terms a vacuum can be applied to the chamber in the housing, wherein a perforation as a component of the holding arrangement is formed in the retaining section of the rubber-elastic membrane so that the vacuum applied to the chamber is present by way of the perforation on the outer side of the retaining section of the rubber-elastic membrane for holding a workpiece to be processed.

In a further realized embodiment there can additionally be arranged on the inner side of the retaining section of the rubber-elastic membrane a semi-permeable membrane section covering the perforation, in that case enabling exchange of air by way of the perforation, but preventing passage of liquid through the perforation into the chamber. Such a semi-permeable membrane section—for example in the form of a lipophilic polymer membrane such as used in water-repellent rainwear-here serves primarily as a safety element or for system protection if in the course of processing of the workpiece held at the retainer the workpiece for whatever reason is lost. The semi-permeable membrane section then prevents, in particular, the chamber from being flooded with, for example, a liquid cooling lubricant as a consequence of the prevailing vacuum, which could place at risk correct functioning of the support arrangement and ultimately of the entire retainer.

In that regard, as indicated in FIG. 6 of earlier German Patent Application DE 10 2021 005 202.1 (DE 10 2021 005 202 A1) by a dotted line at the reference numeral 112 the semi-permeable membrane section covers the perforation with its plurality of openings in the retaining section over the whole area on the inner side of the rubber-elastic membrane. An embodiment of the rubber-elastic membrane with such a system protection for the retainer would be desirable, particularly without the retaining section of the rubber-elastic membrane in that case being subject to excessive stiffening.

What is desired is to provide, particularly for a production process chain ideally managing entirely without blocking, an elastic membrane for a retainer for the processing of optical workpieces, namely spectacle lenses, which generally addresses the problems described above with respect to the prior art and specifically promotes as permanently as possible an excellent capability of adaptation of the retainer to the workpieces to be retained thereat and processed. What is also desired is to provide a retainer, which is equipped with such an elastic membrane, for the processing of optical workpieces, in particular spectacle lenses, which is capable of holding and supporting the workpiece, during workpiece processing, in a manner which is more reliable in terms of process and without workpiece deformations detracting from processing quality.

### Illustration of the Invention

According to one aspect of the invention an elastic membrane for a retainer for the processing of optical workpieces, particularly spectacle lenses, each with two workpiece surfaces and a workpiece edge therebetween is constructed by way of a securing section for—with respect to maintenance and repair of the retainer or exchange of the membrane for a replacement membrane, preferably detachable-mounting on a housing of the retainer, so as to bound therein a chamber by a retaining section, which is connected with the securing section, of the elastic membrane, which has an outer side, on which a workpiece to be processed can be placed over an area by one of its workpiece surfaces, and an inner side, which is adapted for contact with a support arrangement, which is received in the chamber of the retainer, for the workpiece, wherein the retaining section of the elastic membrane has as a component of a holding arrangement for the workpiece a perforation with at least one opening, which connects the inner side with the outer side and by way of which a vacuum applied to the chamber of the retainer can be conducted to the outer side, and wherein associated with the at least one opening is a semi-permeable functional membrane which extends merely locally in a region directly adjoining the opening and which is permeable by gas, but opposes passage of liquid through the at least one opening.

An important advantage in the use of the claimed elastic membrane with its perforation as a component of a holding arrangement of the retainer in accordance with the operating principle of “vacuum” is at the outset that the holding forces are simple to control not only with respect to their presence or absence (i.e. holding force “on” or “off”) in the process, but also in their level, so that the workpiece can be held with greater or lesser strength at the retaining section of the elastic membrane in dependence on, for example, its geometry and/or its material and the properties thereof and/or on the progress of processing and/or on the respectively acting processing forces. In that case, satisfactory and easy controllability of the holding forces at the retainer is also conducive to a high level of process reliability.

In addition, the elastic membrane offers the advantage that the workpiece to be processed is protected on the retainer at its retained workpiece surface without great effort, in particular by the retaining section of the elastic, especially rubber-elastic, membrane. The use of a preferably rubber-like material in the contact region for the workpiece in that case also serves the purpose of being able to accept possible transverse forces and/or torsional moments during processing of the workpiece as a consequence of a comparatively high co-efficient of friction without giving rise to transverse displacement or turning of the workpiece on the elastic membrane, which in a given case could also unintentionally expose the perforation in the retaining section thereof.

The functional membrane associated with the at least one opening of the perforation in the retaining section of the elastic membrane in that regard advantageously ensures the afore-mentioned system protection in that through provision of a liquid block there is prevention of induction of, for example, liquid cooling lubricant into the chamber of the retainer as a consequence of a prevailing vacuum if the perforation in the retaining section is not covered or completely covered by a workpiece resting on the outer side.

Due to the fact that the functional membrane—by contrast with the solution in earlier German Patent Application DE 10 2021 005 202.1 (DE 10 2021 005 202 A1)—in that case extends only in a region in the immediate vicinity of the opening of the retaining section of the elastic membrane then insofar as the perforation in the retaining section merely partly covers over a small area or partly strengthens the retaining section thereat the presence of the functional membrane leads to only an insignificant stiffening of the retaining section. As a result, the retaining section of the elastic membrane can have a substantially constant, high level of flexibility over its area and is overall capable of satisfactorily adapting to or nesting against the applied workpiece surface of a workpiece to be processed. In use of the elastic membrane at the retainer this is on the one hand advantageously conducive to the desired whole-area support of the workpiece to be processed and on the other hand also prevents undesired “images” or “prints” of the elastic membrane on workpieces, which are retained at the retainer, of comparatively soft (plastics) materials.

According to a further aspect of the invention a retainer for the processing of optical workpieces, particularly spectacle lenses, each with two workpiece surfaces and a workpiece edge therebetween, comprises a housing with a holding arrangement for a workpiece to be processed and a support arrangement therefor, which comprises a plurality of pins received in a chamber provided in the housing, which at least for the major part are separately longitudinally displaceable and which are selectively fixable against longitudinal displacement with respect to the housing by a clamping mechanism and by the pin ends thereof serve the purpose of firmly supporting over an area the workpiece, which is held by one of its workpiece surfaces at the retainer by way of the holding arrangement, at the workpiece surface facing the pins ends in accordance with the geometry thereof, wherein according to the invention the afore-described elastic membrane is mounted-preferably detachably-on the housing of the retainer, which membrane together with the housing bounds the chamber and the perforation is formed in the retaining section of the membrane as a component of the holding arrangement so that a vacuum applied to the chamber is present by way of the perforation on the outer side of the retaining section for holding the workpiece.

The retainer according to one aspect of the invention combines different functions significant for high-quality processing of areal workpieces. Areal workpieces such as, for example, spectacle lenses, are distinguished by the fact that they have significantly larger dimensions in width direction and length direction than in thickness direction. This workpiece geometry in the case of processing by machining has the consequence that the workpiece itself particularly in the case of separating forces engaging near the edge of the workpiece and directed away from the workpiece forms a comparatively large lever arm which involves a risk of the workpiece being “levered off” its mount during the machining. At the same time, the comparatively small thickness of the workpiece specifically creates a rather small moment of resistance to bending, with the risk of an (at least) elastic deformation under the respectively prevailing processing forces. The requirements resulting therefrom for a workpiece retainer which functions reliably and is conducive to high processing quality, namely on the one hand reliably holding the areal workpiece during processing and on the other hand sufficiently supporting or propping up against undesired deformations, are addressed in special manner by the retainer according to the invention with the holding and supporting arrangements thereof.

In that regard, the configuration of the support arrangement in accordance with one aspect of the invention with a plurality of pins which for at least the major part are individually longitudinally displaceable and the pin ends of which are capable of firmly supporting over an area the workpiece, which is held by one of its workpiece surfaces at the elastic membrane of the retainer by way of the holding arrangement, at the workpiece surface facing the pin ends in accordance with the geometry thereof, at the outset advantageously enables very accurate “forming” to the workpiece surface, which is placed on the retaining section of the elastic membrane of the retainer, of the workpiece to be retained before the pins are clamped by the clamping mechanism so as to provide a fixed or rigid support surface for the workpiece. Thus, according to the invention there are no larger cavities, into which the workpiece retained at the retainer could “deflect in” during the processing, present under the workpiece.

This very precise forming to the workpiece surface, which is placed on the retaining section of the elastic membrane, is promoted by the afore-described design of the elastic membrane, which by its functional membrane or membranes present locally only to very limited extent in the region of the opening or openings of the perforation in the retaining section has a high degree of flexibility, which is also substantially constant as seen over the area.

The effects and advantages of the holding arrangement, which is configured in accordance with the invention, of the retainer to which the retaining section of the elastic membrane perforated and functionally equipped in special mode and manner belongs were already discussed above with respect to the elastic membrane, to which to that extent reference is again made. Further effects and advantages of the retainer according to the invention are in addition the subject of German Patent Application DE 10 2023 110 130.7, which was already mentioned in the introductory portion of the description and was filed at the same time, of the same applicant, to which at this point reference is once again also made.

In an advantageous embodiment of the elastic membrane it can be provided that the at least one opening of the perforation in the retaining section has opening regions of different cross-section as seen in longitudinal direction and the cross-section of the respective opening region on the outer side of the retaining section is smaller than on the inner side of the retaining section and/or that the at least one opening of the perforation in the retaining section on the outer side of the retaining section has a substantially round opening region with a diameter greater than or equal to 0.5 millimeters and smaller than or equal to 3.0 millimeters and/or that the at least one opening of the perforation in the retaining section on the inner side of the retaining section has an opening region which has a star-shaped cross-section or is substantially round with a diameter greater than or equal to 1.5 millimeters and smaller than or equal to 4.0 millimeters and/or that the at least one opening of the perforation in the retaining section comprises an opening which is central with respect to the center axis of the elastic membrane and/or between three and eighteen openings in the retaining section, which are distributed about the center axis of the elastic membrane preferably at uniform angular spacings from one another on at least one pitch circle-up to, for example, three pitch circles—and/or that the at least one opening of the perforation in the retaining section has only one opening or a few, for example up to seven, openings, which on the outer side of the retaining section open into a distribution structure, which is crystal-shaped or honeycomb-shaped as seen in plan view, of areal, furrow-like depressions for the vacuum.

In principle, the or each opening of the perforation as seen over the length can have, in particular, a constant cross-section. On the other hand, however, opening regions, which have a different cross-section, at an opening—as claimed—offer the advantage that in the case of, in particular, use of longitudinally displaceable pins in the support arrangement of the retainer, which for achieving a highest possible “resolution” have a comparatively small diameter, it is possible to reduce the risk of a pin entirely covering or “blocking” the or an opening of the perforation on the inner side of the retaining section, which could obstruct or prevent conducting of the vacuum to the outer side of the retaining section of the elastic membrane.

Designing the cross-section of the outer and/or inner opening regions of the at least one opening of the perforation in a preferred embodiment to be round offers, in particular, the advantage of particularly simple production in, for example, a mode and manner utilizing punching. However, other cross-sectional shapes of the usually static opening regions are also conceivable. For example, an opening region with a star-shaped cross-section on the inner side of the retaining section is, moreover, advantageous with respect to passage of air, which is obstructed as little as possible by the longitudinally displaceable pins of the support arrangement, through the perforation in the retaining section of the elastic membrane.

The diameter of the round opening region on the outer side of the retaining section should be selected so that on the one hand it is smaller as far as possible than a diameter of the longitudinally displaceable pins of the support arrangement so that there is no risk of a pin penetrating the opening, which could lead to damage of the retained workpiece. On the other hand, however, the opening regions should also be sufficiently large so that air is capable of flowing through the opening or openings from the side of higher pressure (at the outer side of the retaining section) to the side of low pressure (at the inner side of the retaining section) as free of hindrance as possible. The above-indicated diameter ranges have proved themselves to be advantageous in tests carried out by the inventors, in which, for example, a sub-atmospheric pressure in a range between −60 and −90 kPa was applied to the chamber of the retainer and the longitudinally displaceable pins had a diameter around 2.5 millimeters at the ends thereof facing the inner side of the retaining section.

The use of an opening centered with respect to the center axis of the elastic membrane and/or a plurality of openings distributed about the center axis on at least one pitch circle, preferably uniformly angularly spaced from one another, has proved expedient particularly for use of the retainer for supported holding of optical workpieces which are round as seen in plan view, such as is the case, for example, with blanks for spectacle lenses. Such an embodiment advantageously ensures distribution of the vacuum as uniformly as possible under the held workpiece and is thus conducive to achieving high holding forces which are capable of reliably holding the workpiece on or at the retainer even when, for example, a turning or milling tool is in engagement with the workpiece-near the workpiece edge—for processing by machining. For, specifically, other workpiece geometries, for example workpieces which are square or rectangular as seen in plan view, the openings of the perforation can obviously also be formed in a different arrangement and/or distribution in the retaining section of the membrane, with the objective of area distribution, which is as uniform as possible, of the vacuum between the retaining section and the workpiece lying thereon.

As an alternative or addition with respect to suitable arrangement or placing of the opening or openings of the perforation in the retaining section of the elastic membrane the above-discussed crystal-shaped or honeycomb-shaped distribution structure can also be formed on the outer side of the retaining section, which serves the same purpose by its relatively flat—for example, between 0.1 and 0.35 millimeters deep-furrow-like cut-outs or depressions, in particular to ensure vacuum distribution which is as uniform as possible at the outer side of the retaining section. In such an embodiment of the elastic membrane it may be also possible for the number of necessary functional membranes to be reduced, because only one opening or a few openings perforates or perforate the retaining section.

Moreover, this distribution structure for the vacuum can preferably be formed in a diameter region smaller than or equal to 45 millimeters with respect to the center axis of the elastic membrane on the outer side of the retaining section, which in the case of workpiece diameters larger than 50 millimeters and smaller than 85 millimeters—as is frequently the case in spectacle lens production-advantageously ensures that no stray air is inducted when a workpiece is held at the retainer in centered manner. Such air would, in particular, undesirably diminish the holding forces. The same criterion preferably also applies to the opening or openings of the perforation in the retaining section, which also should be formed in the retaining section in a diameter region less than or equal to 45 millimeters with respect to the center axis of the elastic membrane so that it or they can be covered by, for example, a blank for a spectacle lens with usual dimensions. However, in correspondence with the respective use requirements it is also conceivable to provide a diameter region larger than 45 millimeters, within which the opening or openings of the perforation is or are formed in the retaining section, particularly also when larger workpieces, for example spectacle lens blanks with a diameter around 85 millimeters or even greater, are to be retained, which then are better held at the retainer. If even smaller workpieces are then to be retained at the retainer, it can be entirely acceptable if perhaps not each opening of the perforation is covered by the workpiece at the retaining section, so that stray air is inducted, which can also be taken into consideration or regulated out within certain limits when the vacuum is generated. In such cases the functional membrane responsible for the respective uncovered opening or openings in any event ensures that no liquid is sucked into the chamber of the retainer.

Particularly with respect to highest possible flexibility and adaptability of the retaining section of the elastic membrane to the confronting workpiece surface of the workpiece to be retained it is preferred if—for the case that the at least one opening of the perforation in the retaining section comprise a plurality of openings-a respective functional membrane is associated with each opening. However, in the case of a plurality of openings the latter can also be combined into several groups, with which a respective functional membrane is associated in close physical proximity: for example in the case of eighteen openings of the perforation in the retaining section, six groups each of three openings with a respective functional membrane per group. In such cases it obviously has to be ensured that the respective functional membrane is locally limited in terms of area to the respective group of openings so that there is no excessive stiffening of the retaining section of the elastic membrane due to the various functional membranes.

In a particularly preferred embodiment of the elastic membrane it can be additionally provided that the or each functional membrane is integrated in the retaining section of the elastic membrane. By comparison with an equally conceivable embodiment of the elastic membrane in which the or each functional membrane is mounted on, for example, the inner side of the retaining section, perhaps by glueing to or glueing on, the above “integrated variant” of the elastic membrane offers, in particular, the advantage that, for example, detaching of the functional membrane or membranes can be reliably avoided under mechanical loading of the elastic membrane during forming to or supporting of the workpiece which is to be processed or is processed. In that regard, the (respective) functional membrane can, in an embodiment of the elastic membrane which is advantageously simple in terms of production, also separate the afore-mentioned cross-sectionally different opening regions of the at least one opening of the perforation in the retaining section.

In a preferred first alternative of the above integrated variant of the elastic membrane this can be of at least two-part construction in the region of the retaining section, with a larger main part and at least one smaller membrane blank which is inserted into an associated, complementary cut-out of the main part and is connected by material couple or force-fit couple, preferably glued, with the main part with interposition of the or each functional membrane.

In this first alternative of the integrated variant of the elastic membrane the main part and the at least one membrane blank preferably have mutually aligned passages which together form the at least one opening of the perforation in the retaining section. By comparison with an equally possible embodiment in which, instead of aligned passages, channels or grooves are formed in the contact region between main part and membrane blank so as to connect mutually offset passages with one another in gas-permeable manner, the provision of passages, which lie in alignment, at the main part and the membrane blank is advantageously connected with a lower production cost.

Further, the main part and the at least one membrane blank in the first alternative of the integrated variant of the elastic membrane can have rotational markings optionally matching each other, for example in the form of a flattening at an otherwise circularly round geometry, which advantageously reduces the cost of production of a gas-permeable connection between the mutual passages.

For preference, the said main part also comprises the afore-mentioned securing section, which is adapted for mounting on the housing of the retainer, of the elastic membrane and/or forms the outer side of the retaining section of the elastic membrane, which is of advantage with respect to sealing of the chamber in the housing of the retainer by comparison with an equally possible embodiment with a membrane blank which lies on the outer side, because the main part is closed through material integrality-apart from the opening or openings of the perforation.

In a preferred development of the first alternative of the integrated variant of the elastic membrane at least one pocket for reception of the respective functional membrane can additionally be formed in the at least one membrane blank. Such an embodiment at the outset offers the advantage that the functional membrane received locally—in particular only in the opening region—in the sandwich of main part and membrane blank does not add in terms of thickness to the overall composite. In principle, such a pocket can in fact be formed also or only in the main part, but the latter forms the outer side of the retaining section of the elastic membrane; however, with respect to avoidance of undesired “images” or “imprints” of the elastic membrane on workpieces, which are retained at the retainer, of comparatively soft (plastics) materials it is of advantage if the main part has a substantially homogenous thickness without a pocket.

In that regard, the at least one pocket for reception of the respective functional membrane can be optionally surrounded by an annular groove serving for reception of an adhesive for the functional membrane. In such an embodiment of the elastic membrane the annular groove during production of the elastic membrane can advantageously facilitate application of the adhesive to or placing thereof on the functional membrane and/or function as a cavity for reception of excess adhesive between the three parts when the sandwich of main part, functional membrane arranged in the pocket and membrane blank inserted into the cut-out of the main part is compressed during a glueing process.

In a second alternative of the above integrated variant of the elastic membrane the or each functional membrane can, however, also be embedded in the material of the retaining section of the elastic membrane, preferably vulcanized in place. This production alternative, which is favorable in cost, for large batches is obviously available only if the material of the functional membrane is capable of withstanding the comparatively high temperatures within a vulcanizing mold.

In a further preferred embodiment of the elastic membrane the securing section can be of annular, preferably circularly annular, construction and the retaining section can be connected with the securing section by way of a bellows section or rolling lobe section. An advantage of such an embodiment by comparison with an equally conceivable, overall substantially planar configuration of the elastic membrane, in which a central retaining section is merely surrounded by an annular securing section, is particularly that the retaining section as a consequence of its “suspension” by way of the bellows section or rolling lobe section can readily execute locally different strokes. If, for example, a spectacle lens as optical workpiece is to be retained at the retainer so as to be tilted in prismatic manner for specific processing procedures and in that case dips by an area section of a workpiece surface significantly more deeply into the retaining section of the elastic membrane than by a diametrically opposite area section of the same workpiece surface the bellows section or rolling lobe section advantageously ensures an appropriate stroke possibility at the retaining section.

In the afore-described embodiment of the elastic membrane with a bellows section or rolling lobe section the latter can optionally be supported radially outside the inner side of the retaining section by at least one elastically deformable shaped part, particularly a molded ring of a foam material. In that regard it can in principle be a separate insert part or a section foamed in place at the membrane. Thus, collapse of the elastic membrane into the chamber at the housing under the action of the vacuum can be avoided in particularly simple manner without the elastic membrane having to be provided in sub-regions with greater wall thicknesses and/or having to be stiffened by a suitable reinforcement, which would be counter-productive with respect to best possible adaptability of the elastic membrane to the workpiece to be held.

In the tests conducted by the inventors it has further proved particularly advantageous specifically with respect to again a best adaptability of the elastic membrane to the workpiece to be received as well as good durability relative to the liquid additives or chemicals optionally used in the respective production step if the elastic membrane is made of NBR or EPDM and/or has a hardness according to SHORE A between 30 and 80, preferably between 40 and 60, and/or has in the region of the retaining section a material thickness between 1.0 millimeter and 4.0 millimeters, preferably between 1.3 millimeters and 3.0 millimeters. Finally, as far as the functional membrane is concerned it has proved in the tests to be advantageous with respect to on the one hand good availability on the market and on the other hand the achieving of desired functionalities if the functional membrane is made of a PTFE fabric and/or is provided with a hydrophobic and/or oleophobic coating and/or has a resistance to penetration of water greater than or equal to 0.7 bars, preferably greater than or equal to 0.8 bars, determined according to ASTM D751, and/or has a throughput of air in the case of a pressure difference of approximately 70 mbar (1.0 psi) between 10 and 100 L/(h×cm²), preferably between 20 and 60 L/(h×cm²), determined according to ASTM D737.

Further features, characteristics and advantages of the elastic membrane according to the invention and the retainer using this elastic membrane are evident to the person ordinarily skilled in the art from the following description of preferred embodiments.

### BRIEF DESCRIPTION OF THE DRAWINGS

The invention is explained in more detail in the following on the basis of preferred embodiments with reference to the accompanying partly schematic drawings, wherein the same or corresponding parts are provided with the same reference numerals and in which:

FIG. 1 shows a part longitudinal sectional view of a retainer according to the invention for the processing of optical workpieces, at which an elastic membrane according to the invention illustrated here in simplified form is detachably mounted, wherein the section course is selected so that a pneumatic connection, which is marked by a dashed line, for evacuation of a chamber receiving a support arrangement of the retainer is apparent, the chamber being bounded by the elastic membrane with a perforation as a component of a holding arrangement of the retainer, by way of which the chamber vacuum is present as indicated outwardly at the elastic membrane for holding a workpiece to be processed;

FIG. 2 shows a side view of an elastic membrane according to a first embodiment of the invention, in a state separated from an associated retainer according to, for example, FIG. 1;

FIG. 3 shows a plan view of the elastic membrane according to FIG. 2 from the right in FIG. 2, with a view of an outer side of a central retaining section for area contact with the workpiece to be processed, in which the afore-mentioned perforation is formed by a plurality of openings which connect the outer side with an inner side of the elastic membrane;

FIG. 4 shows an underneath view of the elastic membrane according to FIG. 2 from the left in FIG. 2, with a view of the inner side of the retaining section for contact with the support arrangement accommodated in the chamber of the retainer according to FIG. 1;

FIG. 5 shows a sectional view of the elastic membrane according to FIG. 2 in correspondence with the section line V-V in FIG. 4, wherein indicated by dashed lines and a dashed cross-hatching is an optional molded ring of a foam material serving for resilient support of a bellows section, which connects the retaining section with an annular securing section, of the elastic membrane;

FIG. 6 shows an enlargement of the detail VI in FIG. 1, which illustrates how a semi-permeable functional membrane, which is indicated here by a thick black dash, is locally integrated in the region of an opening of the perforation in the retaining section of the elastic membrane according to FIG. 2 and, in fact, between a larger main part of the membrane and a smaller membrane blank glued thereto;

FIG. 7 shows an underneath view of the main part, which is here shown individually, of the elastic membrane according to FIG. 2, with a view of a cut-out, which is complementary with the membrane blank, for reception of the membrane blank;

FIG. 8 shows a plan view of the membrane blank, which is also shown individually, of the elastic membrane according to FIG. 2, with a view of a plurality of pockets each for reception of a respective functional membrane;

FIG. 9 shows a perspective exploded illustration of the elastic membrane according to FIG. 2, with—seen from left to right in FIG. 9—the main part, individual functional membranes and the membrane blank prior to glueing thereof;

FIG. 10 shows an underneath view of an elastic membrane according to a second embodiment of the invention, again in a state separated from an associated retainer according to, for example, FIG. 1;

FIG. 11 shows a sectional view of the elastic membrane according to FIG. 10 in correspondence with the section line XI-XI in FIG. 10;

FIG. 12 shows an enlargement of the detail XII in FIG. 11, which illustrates again how a semi-permeable functional membrane is integrated locally in the region of an opening of the perforation in the retaining section of the elastic membrane according to FIG. 10 and, in fact, by embedding in the material of the retaining section;

FIG. 13 shows a perspective view of an insert for a lower part of a vulcanizing mold for producing the elastic membrane according to FIG. 10, in which are mounted, in correspondence with the number of functional membranes of the elastic membrane, retaining members each for a respective functional membrane, the functional membranes being held at the retaining members during the vulcanization process;

FIG. 14 shows a perspective view of a retaining member of the insert, which is shown in FIG. 13, for the lower part of the vulcanizing mold;

FIG. 15 shows a plan view of an elastic membrane according to a third embodiment of the invention, again in a state separated from an associated retainer according to, for example, FIG. 1, with a view of the retaining section of the membrane, the perforation of which has only a few openings which open on the outer side of the retaining section in a distribution structure, which is crystal-shaped as seen in plan view, of areal, furrow-like depressions for the vacuum; and

FIG. 16 shows a plan view of an elastic membrane according to a fourth embodiment of the invention, again in a state separated from an associated retainer according to, for example, FIG. 1, with a view of the retaining section of the membrane, the perforation of which comprises merely a central opening which opens on the outer side of the retaining section in a distribution structure, which is honeycomb-shaped as seen in plan view, of areal, furrow-like depressions for the vacuum.

### DETAILED DESCRIPTION OF THE EMBODIMENT

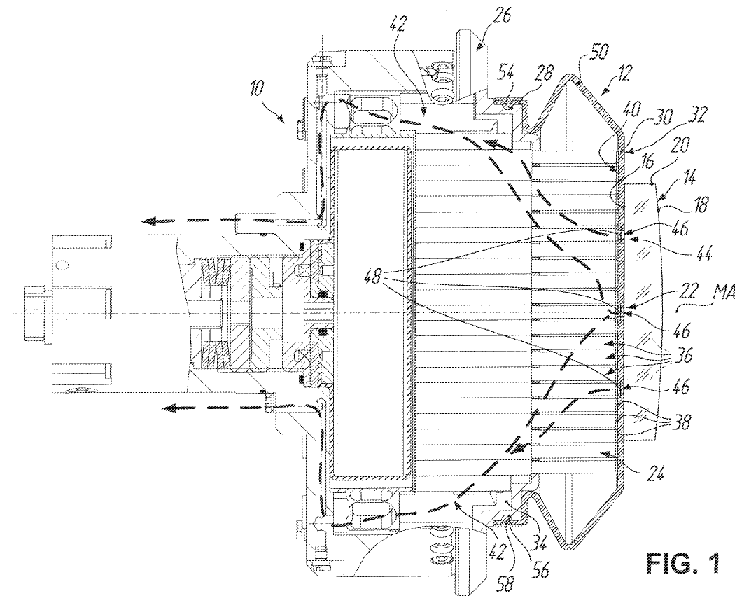

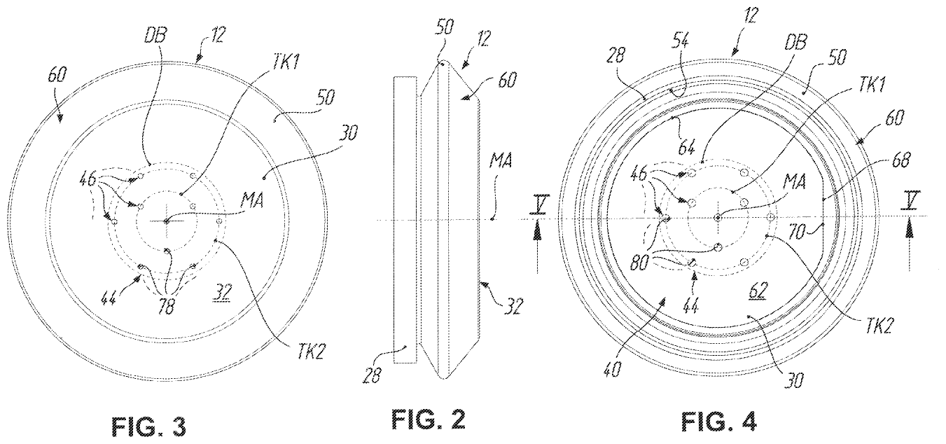

A retainer for the processing of optical workpieces is generally denoted by the reference numeral 10 in FIG. 1. This retainer 10 is the subject of German Patent Application DE 10 2023 110 130.7, which was filed at the same time under the title “Retainer for the processing of optical workpieces, particularly spectacle lenses”, of the same applicant, as already mentioned in the introductory portion of the description. An elastic membrane 12, which is shown in FIG. 1 only in principle and which is, however, still to be described in detail in the following on the basis of FIGS. 2 to 16 by four embodiments, can be used at this retainer 10 or the retainer disclosed in earlier German Patent Application DE 10 2021 005 202.1 (DE 10 2021 005 202 A1), which was also already mentioned above, of the same applicant so as to, especially, process spectacle lenses of plastic thereat as described in document DE 10 2021 004 831 A1 also already cited at the beginning. Reference is again expressly made at this point to these documents (DE 10 2023 110 130.7, DE 10 2021 005 202 A1, DE 10 2021 004 831 A1) with respect to structural details of the retainer as well as to details of use and method. The retainer 10 shall therefore also be described in the following only to the extent appearing necessary for understanding of the present invention.

A spectacle lens 14 as an example for an optical workpiece to be processed is shown in FIG. 1. The spectacle lens 14 has two-optically effective at least at the end of the processing-workpiece surfaces 16, 18 and a workpiece edge 20 therebetween. In the different processing states, i.e. starting from the spectacle lens blank through the partly processed spectacle lens semi-finished product to the spectacle lens processed to finished state, there is always an areal workpiece. As such, the spectacle lens 14 during processing has to be reliably held and at the same time supported against undesired deformations, purposes here served by the retainer 10.

In brief, the retainer 10 comprises—for the afore-mentioned functions of “holding” and “supporting” of a spectacle lens 14 to be processed-broadly a holding arrangement 22 and a supporting arrangement 24 in or at a multi-part housing 26, on which the elastic membrane 22 is mounted by way of an appropriately adapted securing section 28. In that case the elastic membrane 12 has a retaining section 30 which is connected with the securing section 28 and on the outer side 32 of which the spectacle lens 14 according to FIG. 1 can be placed over an area by one (16) of its workpiece surfaces 16, 18.

In addition, the elastic membrane 12 together with the housing 26 bounds a chamber 34 in which a plurality of pins 36, which are separately longitudinally displaceable at least for the major part, of the support arrangement 24 of the retainer 10 is accommodated. The pins 36 can each be brought by a pin end 38 into contact with an inner side 40 of the retaining section 30 of the elastic membrane 12, the inner side 40 being adapted, i.e. in particular, suitably dimensioned, for that purpose. Moreover, the pins 36 can be selectively fixed against longitudinal displacement with respect to the housing 26, i.e. displacement parallel to a center axis MA of retainer 10 and elastic membrane 12, by a clamping mechanism 42 which acts transversely in the illustrated embodiment. The pins 36 then serve by the pin ends 38 thereof the purpose of firmly supporting the spectacle lens 14, which is held by one (16) of its workpiece surfaces 16, 18 at the retainer 10 by way of the holding arrangement 22, over an area at the workpiece 16 facing the pin ends 38 in accordance with the geometry of the surface.

Moreover, as far as the holding arrangement 22 of the retainer 10 is concerned the retaining section 30 of the elastic membrane 12 has as a component of the holding arrangement 22 a perforation 44 with at least one opening 46-three such openings 46 of the perforation 44 are to be seen in the section according to FIG. 1-which connects the inner side 40 with the outer side 22 and by way of which a vacuum (indicated in FIG. 1 by dashed arrows) applied to the chamber 34 can be conducted to the outer side 32. As a result, a vacuum in the chamber 34 is present by way of this perforation 44 on the outer side 32 of the retaining section 30 of the elastic membrane 12 for holding the spectacle lens 14.

In that case, a special feature of the elastic membrane 12 is that associated with the at least one opening 46 in the retaining section 30 is a semi-permeable functional membrane 48, which is illustrated in FIG. 1 only schematically by a black dash and which extends merely locally in a region directly adjoining the opening 46. Thus, in the embodiment according to FIG. 1 in which the perforation 44 in the retaining section 30 of the elastic membrane 12 comprises a plurality of openings 46 a respective functional membrane 48 is associated with each opening 46. In that regard, “semi-permeable” signifies that the (respective) functional membrane 48 is permeable by gas, but opposes passage of liquid through the at least one opening 46. The functional membrane or membranes 48 thus forms or form—as already outlined in the introductory portion of the description-a protective mechanism preventing, in particular, the support arrangement 24 of the retainer 10 with its pins 36 from being damaged by liquid (processing) additive possibly inducted by way of the evacuated chamber 34 in the housing 26. Since the functional membrane or membranes 48 is or are present only very “locally” at the retaining section 30 of the elastic membrane 12 it does not or they do not stiffen the retaining section 30 of the elastic membrane 12, which consequently has a substantially constant high level of flexibility as seen over the area, so that a true-to-shape adaptation at the outer side 32 of the retaining section 30 to the facing workpiece surface 16 of the spectacle lens 14 held at the retainer 10 satisfactorily takes place.

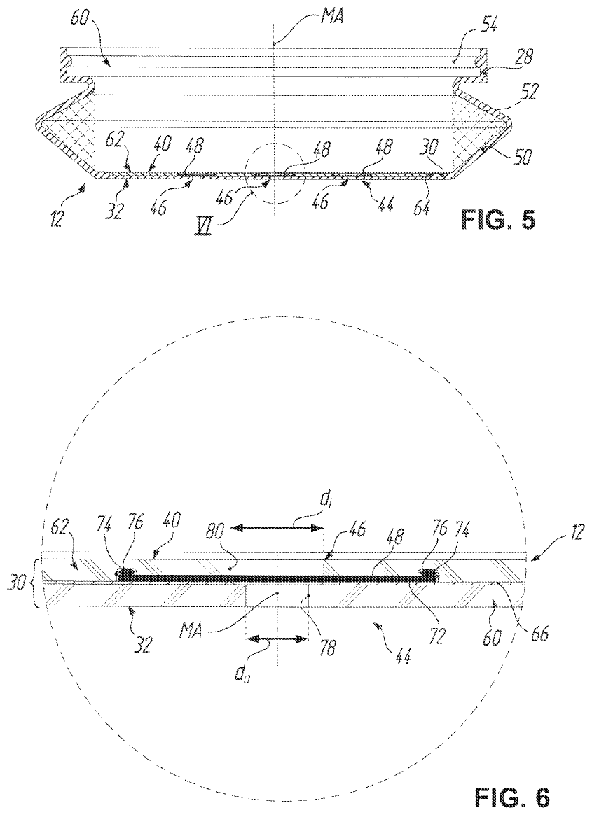

According to FIG. 1 the elastic membrane 12 further comprises a bellows section, here in the form of a bellows section 50, which radially outwardly connects with the retaining section 30 and which in turn goes over into the securing section 28, which is circularly annular in the illustrated embodiment, of the elastic membrane 12. The securing section 28 and the retaining section 30 of the elastic membrane 12 are thus flexibly connected by way of the bellows section 50. In a given case the bellows section 50 can be supported radially outside the inner side 40 of the retaining section 30, thus in a region which in the mounted state of the elastic membrane 12 lies radially outside the pins 36 of the support arrangement 24 of the retainer 10, by at least one elastically deformable shaped part, in particularly a molded ring 52 of a foam material. Such a measure at the elastic membrane 12, which prevents undesired deformation of the elastic membrane 12 particularly in the region of the bellows section 50 when vacuum is applied to the chamber 34, is indicated in FIG. 5 by dashed lines.

Moreover, the elastic membrane 12 has at the inner circumference of the securing section 28 an encircling bead 54 which is fastened in an associated radial groove 56 in the housing 26 of the retainer 10. In that case, a clamping band 58 mounted on the outer circumference of the securing section 28 holds the securing section 28 in interlocking engagement with the radial groove 56 of the housing 26. This connection of the elastic membrane 12 with the housing 26 of the retainer 10 is gas-tight and detachable, so that the elastic membrane 12 as a wear part of the retainer 10 can be easily demounted and exchanged.

Preferred embodiments of the elastic membrane 12 are now shown in FIGS. 2 to 9 (first embodiment), 10 to 12 (second embodiment) and 15 and 16 (third and fourth embodiments, respectively). It is at the outset common to all embodiments that the or each functional membrane 48 is integrated in the retaining section 30 of the elastic membrane 12, i.e. does not lie on the inner side 40 or the outer side 32 of the retaining section 30 or is not secured thereat. The way in which such a “safe-against-loss” integration of the functional membrane or membranes 48 in the retaining section 30 can be concretely realized shall be explained in the following on the basis of the first two embodiments, which show different concepts thereof.

In the first embodiment the elastic membrane 12 in the region of the retaining section 30 is of (at least) two-part construction, which can be best seen in the exploded illustration according to FIG. 9. More precisely, the elastic membrane 12 comprises a larger main part 60 and a (at least one) membrane blank 62 smaller relative thereto. The latter is inserted into an associated complementary recess 64 of the main part 60 and connected by material couple or force-fit couple with, preferably glued to, the main part 60 with interposition of the or each functional membrane 48. A corresponding adhesive layer is provided with the reference numeral 66 in the enlargement according to FIG. 6. In that case the main part 60 and the membrane blank 62 have passages which are aligned with one another and which together form the openings 46 of the perforation 44 in the retaining section 30 of the elastic membrane 12.

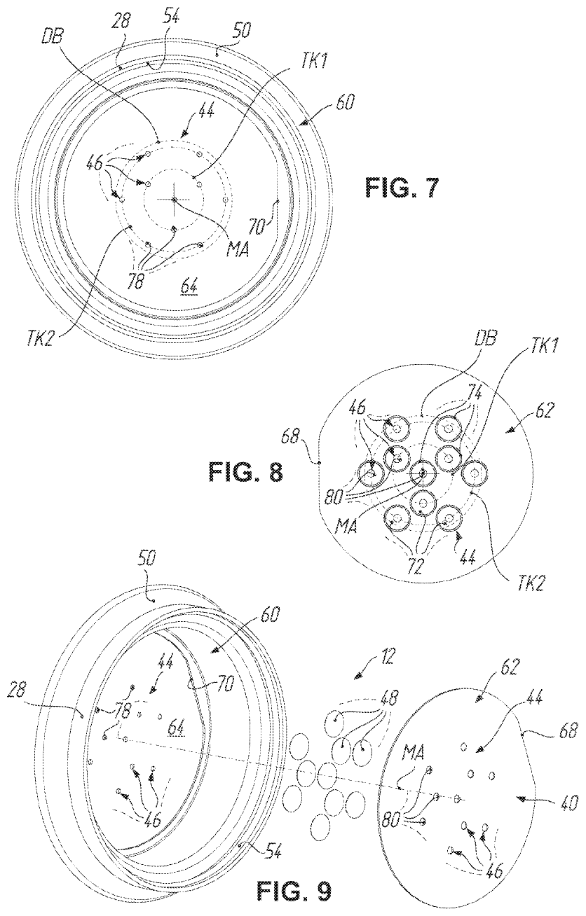

As can be best seen in the individual part illustrations according to FIGS. 7 to 9, the main part 60 and the membrane blank 62 have mutually matching rotational markings 68, 70-here in the form of straight edge sections at an otherwise circularly round edge of the membrane blank 62 or the recess 64 in the main part 60-which simplify alignment of the passages in the main part 60 and membrane blank 62. The individual part illustrations in FIGS. 7 and 9 also show that in the embodiment illustrated here the main part 60 also includes the securing section 28 of the elastic membrane 12. Moreover, the main part 60 in this embodiment forms the outer side 32 of the retaining section 30 of the elastic membrane 12.

As FIGS. 6 and 8 in addition show, in correspondence with the number of functional membranes 48 (one or) several pockets 72 for tight reception of the respective-circularly round in the embodiment-functional membranes 48 (is or) are formed in the membrane blank 62. According to FIGS. 6 and 8 the or each pocket 72 for reception of the respective functional membrane 48 is surrounded by an annular groove 74 serving for reception of an adhesive 76 (see FIG. 6) for the functional membrane 48.

Moreover, as can be best seen in FIG. 6 the or each opening 46 of the perforation 44 in the retaining section 30 of the elastic membrane 12 has opening regions 78, 80 which are different in cross-section as seen in longitudinal direction, wherein the cross-section of the respective opening region 78 on the outer side 32 of the retaining section 30 is smaller than on the inner side 40 of the retaining section 30. Thus, according to the illustrated embodiments the (at least one) opening 46 of the perforation 44 on the outer side 32 of the retaining section 30 can have a substantially round opening region 78 with, for example, a diameter da greater than or equal to 0.5 millimeters and smaller than or equal to 3.0 millimeters. By contrast, on the inner side 40 of the retaining section 30 the (at least one) opening 46 of the perforation 44 can have an opening region 80, which is also substantially round, with, for example, a diameter di greater than or equal to 1.5 millimeters and smaller than or equal to 4.0 millimeters. In an actual embodiment the respective opening 46 can thus have, for example, inwardly a diameter of 3 millimeters and outwardly a diameter of 2 millimeters.

As far as the number and distribution of the openings 46 of the perforation 44 in the retaining section 30 of the elastic membrane 12 are concerned, the perforation 44 in the retaining section 30 can have an opening 46 which is central with respect to the center axis MA of the elastic membrane 12 and/or between three and eighteen openings 46, which are distributed around the center axis MA of the elastic membrane 12 preferably with uniform angular spacing from one another on at least one pitch circle TK1, TK2. In concrete terms, in FIGS. 3 and 4 or 7 and 8 there are shown for the first embodiment a central opening 46, three openings 46 on the inner pitch circle TK1 and six openings 46 on the outer pitch circle TK2.

The openings 46 of the perforation 44 are in that case preferably formed in a diameter region DB smaller than or equal to 45 millimeters with respect to the center axis MA of the elastic membrane 12 in the retaining section 30, so that they can be covered by a blank for a spectacle lens 14 with usual dimensions. Fundamentally, in that case there is between the number of openings 46 of the perforation 44 in the retaining section 30 and the cross-section of the respective opening 46 such a dependence that in the case of more openings 46 the respective clear opening cross-section should be smaller and in the case of fewer openings 46 the respective clear opening cross-section should be larger.

As evident particularly from FIG. 6, the respective functional membrane 48 separates the cross-sectionally different opening regions 78, 80 of the corresponding opening 46. In that case the functional membrane 48 as seen in longitudinal direction of the respective opening 46 lies substantially centrally in the material of the retaining section 30 of the elastic membrane 12.

For production of the elastic membrane 12 according to the first embodiment in accordance with FIGS. 2 to 9 the procedure is, for example, as follows:

The larger main part 60 and the smaller membrane blank 62 are at the outset shaped and vulcanized from the same starting material, wherein the shaping in that case takes place by, for example, pressing, transfer molding or injection molding under pressure and temperature with simultaneous vulcanization. The material for the functional membrane or membranes 48 is usually available as rolls and can be made up by, for example, cutting out or punching out in correspondence with the shape and size of the pockets 72 in the membrane blank 62.

After preparation of the individual component of the elastic membrane 12 the main part 60 and the membrane blank 62 are cleaned and degreased in the region of the later contact or glueing areas before a contact adhesive (later adhesive layer 66) for joining the contact surfaces is uniformly coated thereon. It is important in the selection of a suitable contact adhesive that after hardening of the contact adhesive the resulting adhesive layer 66 is still as flexible as possible.

The contact adhesive then has to be deaerated, during which the adhesive 76 is introduced at the membrane blank 62 into the annular grooves 74 surrounding the pockets 72 for reception of the respective functional membranes 48. The functional membranes 48 are then placed in the pockets 72 and fixed by the adhesive 76 in the region of the annular grooves 74.

After deaeration the contact surfaces at the main part 60 and the membrane blank 62 must be joined for the glueing under application of a suitable contact force. For that purpose, the main part 60 and the membrane blank 62 furnished with the functional membranes 48 are so positioned in opposite inserts of a press that the contact surfaces which are opposite as seen along the center axis MA are aligned in adaptation to one another by way of the rotational markings 68, 70 at the main part 60 and membrane blank 62, respectively. In this orientation the passages formed in the main part 60 and membrane blank 62 align with one another so that after the subsequent compression these in common form the openings 46 of the perforation 44 in the retaining section 30 of the elastic membrane 12.

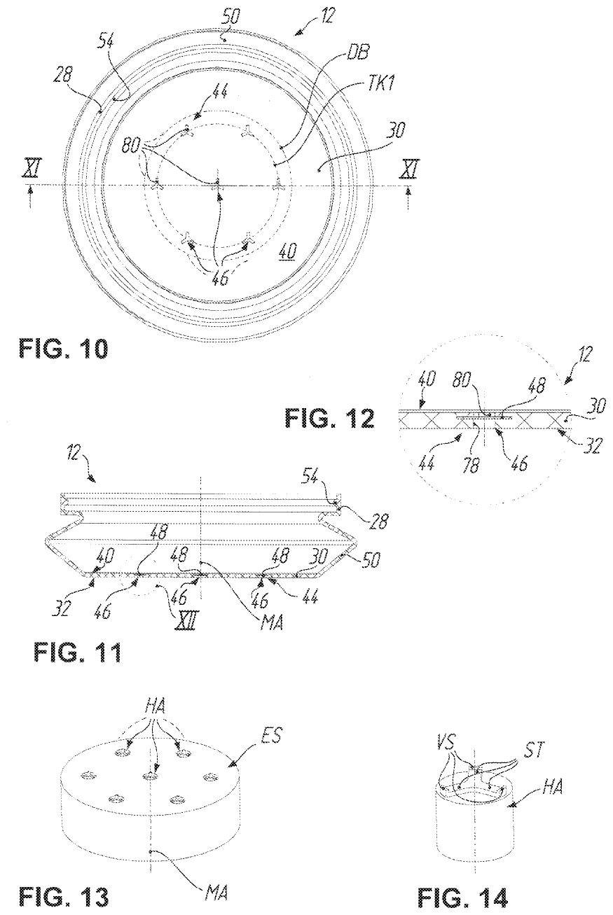

In the second embodiment shown in FIGS. 10 to 14 the respective functional membrane 48 does not lie inserted between individual parts in the retaining section 30 of the elastic membrane 12 so as to equip the respective opening 46 with the already discussed semi-permeable protection function, but is embedded in the material of the retaining section 30 of the elastic membrane 12. This can take place, for example, by vulcanization of the functional membrane 48 in place.

In addition, the elastic membrane 12 according to the second embodiment differs from the elastic membrane 12 according to the first embodiment in that the opening region 80, which is at the inner side, of the respective opening 46 of the perforation 44 in the retaining section 30 (cf. FIG. 12) has a star-shaped cross-section as can be best seen in FIG. 10, whereas the opening region 78 of the respective opening 46 on the outer side 32 of the retaining section 30 has a round cross-section as already described above with respect to the first embodiment. In that case, the cross-sectional area of the respective opening 46 on the outer side 32 (round cross-section) of the retaining section 30 of the elastic membrane 12 is, however, again smaller than the cross-sectional area of the corresponding opening 46 on the inner side 40 (star-shaped cross-section) of the retaining section 30.

In order to produce the elastic membrane 12 according to the second embodiment in accordance with FIGS. 10 to 14 the procedure is, for example, as follows:

Shaping of the elastic membrane 12 takes place here by transfer molding or injection molding under pressure and temperature with simultaneous vulcanization in a vulcanizing mold, which is not further illustrated here, with a lower part and an upper part.

An insert ES, which is illustrated in FIG. 13, with bores for fixing of cylindrical holders HA (see FIG. 14) for the functional membranes 48 is provided in the lower part of the vulcanizing mold. Each holder HA has on its end facing the upper part of the vulcanizing mold webs ST, which are arranged in star shape, for the deposit of a functional membrane 48, the webs being provided at the radially outer ends thereof with projections VS with which the edges of the round functional membranes 48 can be brought into mechanically positive contact.

The upper part of the vulcanizing mold has cylindrical counter-holders (not shown) which are arranged to be complementary with the holders HA in the insert ES and which in the assembled state of the vulcanizing mold project in the direction of the lower part and bear in retaining manner centrally on the sides, which are remote from the webs ST, of the functional membranes 48 placed on the holders HA. During subsequent filling of the vulcanizing mold the regions of the functional membranes 48 not covered or screened by the webs ST and the cylindrical counter-holders are surrounded by the material to be vulcanized.

As a consequence thereof after mold removal of the elastic membrane 12 following the vulcanization the cross-sectionally different opening regions 78, 80 separated by the functional membranes 48 remain on the inner side 40 or the outer side 32 of the retaining section 30. These opening regions have on the outer side 32 of the retaining section 30 round cross-sections corresponding with the cylindrical counter-holders at the upper part of the vulcanizing mold and on the inner side 40 of the retaining section 30 star-shaped cross-sections corresponding with the webs ST arranged in star-shape at the holders HA in the lower part of the vulcanizing mold, by way of which air can be sucked from outside through the functional membranes 48.

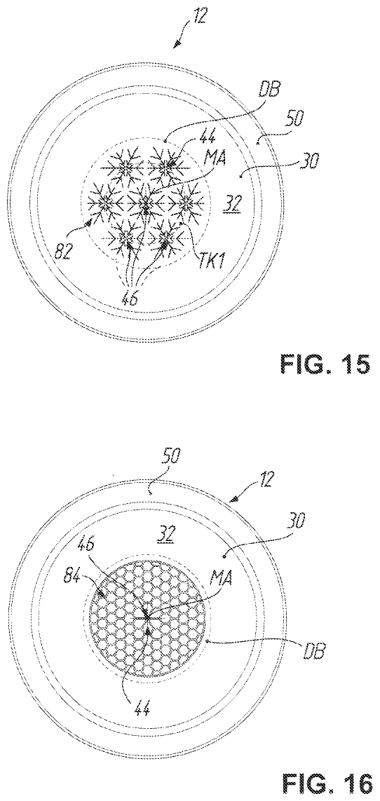

In the further embodiments according to FIGS. 15 and 16 the perforation 44 in the retaining section 30 of the elastic membrane 12 comprises either only one opening 46, which in the fourth embodiment according to FIG. 16 is central with respect to the center axis MA, or some small openings 46, in the third embodiment according to FIG. 15 a central opening 46 and six further openings 46 arranged to be uniformly angularly spaced from one another on a pitch circle TK1 with respect to the center axis MA.

In the third embodiment the total of seven openings 46 opens into a distribution structure 82 for the vacuum, which, as shown in FIG. 15 is formed to be crystal-shaped as seen in plan view. By contrast, in the fourth embodiment according to FIG. 16 the single central opening 46 opens into a distribution structure 84, which is honeycomb-shaped as seen in plan view, for the vacuum.

The two distribution structures 82, 84 are formed on the outer side 32 of the retaining section 30 of the elastic membrane 12 and include areal furrow-like depressions so as to distribute the vacuum under a spectacle lens 14 which has been placed on. In other words, these distribution structures 82, 84 “collect” the air present under a spectacle lens 14 placed on the retainer 10 and conduct it away via the opening or openings 46 of the perforation 44 in the retaining section 30 of the elastic membrane 12 so that the vacuum is present under the spectacle lens 14 for the retention.

In that case, the two distribution structures 82, 84 for the vacuum are formed in a diameter region DB smaller than or equal to 45 millimeters with respect to the center axis MA of the elastic membrane 12 on the outer side 32 of the retaining section 30 so that they can be covered by a blank for a spectacle lens 14 with usual dimensions. Distribution structures of that kind can already be produced during molding of the elastic membrane 12 by corresponding positive structures in the vulcanizing mold.

With respect to the membrane 12 it is additionally to be said at this point for all embodiments that its resilient characteristics basically should be selected so that the retaining section 30 of the elastic membrane 12 on the one hand is capable of evening out the discrete points of the pin ends 38 of the individual pins 36 of the support arrangement 24 of the retainer 10 so that a continuous retaining surface for the spectacle lens 14 to be retained arises. On the other hand, however, the retaining section 30 of the elastic membrane 12 should not be too soft so as to not make possible any appreciable movement of the supported and held spectacle lens 14 on the retainer 10 and also to prevent the functional membrane or membranes 48 from “pressing through” towards the outer side 32 of the retaining section 30 and then in a given case producing undesired “images” or “imprints” on the spectacle lens 14 held at the retainer 10, particularly when the lens is made of a comparatively soft plastics material.

As tests carried out by the inventors have shown the materials NBR (nitrile butadiene rubber) or EPDM (ethylene-propylene-diene; M group) are particularly suitable for formation of the elastic membrane 12, which should preferably have a hardness according to SHORE A between 30 and 80, more preferably between 40 and 60. Moreover, the elastic membrane 12 should have a material thickness between 1.0 millimeter and 4.0 millimeters, preferably between 1.3 millimeters and 3.0 millimeters, in the region of the retaining section 30.

Finally, with respect to the functional membrane 48 it can also be stated for all embodiments that in the tests carried out by the inventors functional membranes 48 being made of a fabric of PTFE (polytetrafluorethylene) and provided with a hydrophobic and/or oleophobic coating have proved themselves. With respect to the semi-permeable function thereof the functional membrane or membranes 48 should have a resistance to penetration by water of greater than or equal to 0.7 bar, preferably greater than or equal to 0.8 bar, determined in accordance with ASTM D751. As far as gas permeability is concerned, an air throughput in the case of a pressure difference of approximately 70 mbar (1.0 psi) of between 10 and 100 L/(h×cm²), preferably between 20 and 60 L/(h×cm²), determined in accordance with ASTM D737 should be possible.

An elastic membrane for a retainer for the processing of optical workpieces is adapted by way of a securing section for mounting on a housing of the retainer so as to bound therein a chamber by a retaining section connected with the securing section. The retaining section has an outer side on which a workpiece can be placed over an area by one workpiece surface and an inner side which is adapted for contact with a support arrangement, which is accommodated in the chamber, for the workpiece. The retaining section has as a component of a holding arrangement for the workpiece a perforation with at least one opening which connects inner side and outer side and by way of which a vacuum applied to the chamber can be conducted to the outer side. Associated with the opening is a semi-permeable, i.e. gas-permeable and liquid-blocking, functional membrane which extends merely locally in a region directly adjoining the opening. A retainer with such an elastic membrane is also disclosed.

Other variations and modifications are possible without departing from the scope and spirit of the present invention as defined by the appended claims.

What is claimed is:

1. An elastic membrane (12) for a retainer (10) for processing optical workpieces (14), each with two workpiece surfaces (16, 18) and a workpiece edge (20) therebetween, wherein the membrane (12) is constructed with a securing section (28) for mounting on a housing (26) of the retainer (10) so as to bound therein a chamber (34) by a retaining section (30), which is connected with the securing section (28) and which has an outer side (32), on which a workpiece (14) to be processed can be placed over an area with one of its workpiece surfaces (16, 18), and an inner side (40), which is constructed to contact a support arrangement (24) for the workpiece (14), that is received in the chamber (34), wherein the retaining section (30) has as a component of a holding arrangement (22) for the workpiece (14) a perforation (44) with at least one opening (46), which connects the inner side (40) with the outer side (32) and by way of which a vacuum applied to the chamber (34) can be conducted to the outer side (32), and wherein associated with the at least one opening (46) is a semi-permeable functional membrane (48) which extends merely locally in a region directly adjoining the opening (46) and which is permeable for gas, but opposes passage of liquid through the at least one opening (46).

2. An elastic membrane (12) according to claim 1, wherein the at least one opening (46) of the perforation (44) in the retaining section (30)
has as seen in longitudinal direction opening regions (78, 80) of different cross-section and the cross-section of the respective opening region (78, 80) on the outer side (32) of the retaining section (30) is smaller than on the inner side (40) of the retaining section (30) and/or
has on the outer side (32) of the retaining section (30) a substantially round opening region (78) with a diameter (da) greater than or equal to 0.5 millimeters and smaller than or equal to 3.0 millimeters and/or
has on the inner side (40) of the retaining section (30) an opening region (80) which has a star-shaped cross-section or is substantially round with a diameter (di) greater than or equal to 1.5 millimeters and smaller than or equal to 4.0 millimeters and/or
is formed in a diameter region (DB) smaller than or equal to 45 millimeters with respect to a center axis (MA) of the elastic membrane (12) in the retaining section (30) and/or
has an opening (46) which is central with respect to the center axis (MA) of the elastic membrane (12) and/or between three and eighteen openings (46) in the retaining section (30), which are distributed preferably with uniform angular spacing from one another about the center axis (MA) of the elastic membrane (12) on at least one pitch circle (TK1, TK2) and/or
has only one opening or a few openings (46), which opens or open on the outer side (32) of the retaining section (30) into a distribution structure (82, 84), which is crystal-shaped or honeycomb-shaped as seen in plan view, of areal furrow-like depressions for the vacuum.

3. An elastic membrane (12) according to claim 2, wherein the distribution structure (82, 84) for the vacuum is formed in a diameter region (DB) smaller than or equal to 45 millimeters with respect to the center axis (MA) of the elastic membrane (12) on the outer side (32) of the retaining section (30).

4. An elastic membrane (12) according to claim 3, wherein
the at least one opening (46) of the perforation (44) in the retaining section (30) has a plurality of openings (46), with each of which a respective functional membrane (48) is associated, and/or
the or each functional membrane (48) is integrated in the retaining section (30) of the elastic membrane (12).

5. An elastic membrane (12) according to claim 4, wherein the functional membrane (48) separates the opening regions (78, 80) of different cross-section of the at least one opening (46).

6. An elastic membrane (12) according to claim 5, wherein the elastic membrane (12) is of at least two-part construction in the region of the retaining section (30), with a larger main part (60) and at least one smaller membrane blank (62), which is inserted into an associated complementary cut-out (64) of the main part (60) and is connected by material bond or force-fitting, preferably glued, with the main part (60) with interposition of the or each functional membrane (48).

7. An elastic membrane (12) according to claim 6, wherein
the main part (60) and the at least one membrane blank (62) have mutually aligned passages which together form the at least one opening (46) of the perforation (44) in the retaining section (30) and/or
the main part (60) and the at least one membrane blank (62) have rotational markings (68, 70) matching each other and/or
the main part (60) also comprises the securing section (28) of the elastic membrane (12) and/or
the main part (60) forms the outer side (32) of the retaining section (30) of the elastic membrane (12).

8. An elastic membrane (12) according to claim 7, wherein at least one pocket (72) for reception of the respective functional membrane (48) is formed in the at least one membrane blank (62).

9. An elastic membrane (12) according to claim 8, wherein the at least one pocket (72) for reception of the respective functional membrane (48) is surrounded by an annular groove (74) serving for reception of an adhesive (76) for the functional membrane (48).

10. An elastic membrane (12) according to claim 5, wherein the or each functional membrane (48) is embedded in, preferably vulcanized into, the material of the retaining section (30) of the elastic membrane (12).

11. An elastic membrane (12) according to claim 10, wherein the securing section (28) is formed to be annular and the retaining section (30) is connected with the securing section (28) by way of a bellows section or rolling lobe section (50).

12. An elastic membrane (12) according to claim 11, wherein the bellows section or rolling lobe section (50) is supported radially outside the inner side (40) of the retaining section (30) by at least one resiliently deformable shaped part (52), particularly a molded ring of a foam material.

13. An elastic membrane (12) according to claim 12, wherein the elastic membrane (12) is made of NBR or EPDM and/or
has a hardness according to SHORE A between 30 and 80, preferably between 40 and 60, and/or
has in the region of the retaining section (30) a material thickness between 1.0 millimeter and 4.0 millimeters, preferably between 1.3 millimeters and 3.0 millimeters.

14. An elastic membrane (12) according to claim 13, wherein the functional membrane (48)
is made of a PTFE fabric and/or
is provided with a hydrophobic and/or oleophobic coating and/or
has a penetration resistance to water greater than or equal to 0.7 bar, preferably greater than or equal or 0.8 bar, determined according to ASTM D751, and/or
has an air throughput in the case of a pressure difference of approximately 70 mbar (1.0 psi) between 10 and 100 L/(h×cm²), preferably between 20 and 60 L/(h×cm²), determined according to ASTM D737.

15. An elastic membrane (12) according to claim 1, wherein
the at least one opening (46) of the perforation (44) in the retaining section (30) has a plurality of openings (46), with each of which a respective functional membrane (48) is associated, and/or
the or each functional membrane (48) is integrated in the retaining section (30) of the elastic membrane (12).

16. An elastic membrane (12) according to claim 2, wherein the functional membrane (48) separates the opening regions (78, 80) of different cross-section of the at least one opening (46).

17. An elastic membrane (12) according to claim 15, wherein the elastic membrane (12) is of at least two-part construction in the region of the retaining section (30), with a larger main part (60) and at least one smaller membrane blank (62), which is inserted into an associated complementary cut-out (64) of the main part (60) and is connected by material bond or force-fitting, preferably glued, with the main part (60) with interposition of the or each functional membrane (48).

18. An elastic membrane (12) according to claim 17, wherein
the main part (60) and the at least one membrane blank (62) have mutually aligned passages which together form the at least one opening (46) of the perforation (44) in the retaining section (30) and/or
the main part (60) and the at least one membrane blank (62) have rotational markings (68, 70) matching each other and/or
the main part (60) also comprises the securing section (28) of the elastic membrane (12) and/or
the main part (60) forms the outer side (32) of the retaining section (30) of the elastic membrane (12).

19. An elastic membrane (12) according to claim 18, wherein at least one pocket (72) for reception of the respective functional membrane (48) is formed in the at least one membrane blank (62).

20. An elastic membrane (12) according to claim 19 wherein the at least one pocket (72) for reception of the respective functional membrane (48) is surrounded by an annular groove (74) serving for reception of an adhesive (76) for the functional membrane (48).

21. An elastic membrane (12) according to claim 1, wherein the or each functional membrane (48) is embedded in, preferably vulcanized into, the material of the retaining section (30) of the elastic membrane (12).

22. An elastic membrane (12) according to claim 1, wherein the securing section (28) is formed to be annular and the retaining section (30) is connected with the securing section (28) by way of a bellows section or rolling lobe section (50).

23. An elastic membrane (12) according to claim 23, wherein the bellows section or rolling lobe section (50) is supported radially outside the inner side (40) of the retaining section (30) by at least one resiliently deformable shaped part (52), particularly a molded ring of a foam material.

24. An elastic membrane (12) according to claim 1, wherein the elastic membrane (12) is made of NBR or EPDM and/or
has a hardness according to SHORE A between 30 and 80, preferably between 40 and 60, and/or
has in the region of the retaining section (30) a material thickness between 1.0 millimeter and 4.0 millimeters, preferably between 1.3 millimeters and 3.0 millimeters.

25. An elastic membrane (12) according to claim 1, wherein the functional membrane (48)
is made of a PTFE fabric and/or
is provided with a hydrophobic and/or oleophobic coating and/or
has a penetration resistance to water greater than or equal to 0.7 bar, preferably greater than or equal or 0.8 bar, determined according to ASTM D751, and/or
has an air throughput in the case of a pressure difference of approximately 70 mbar (1.0 psi) between 10 and 100 L/(h×cm²), preferably between 20 and 60 L/(h×cm²), determined according to ASTM D737.

26. A retainer (10) for processing optical workpieces (14), particularly spectacle lenses, each with two workpiece surfaces (16, 18) and a workpiece edge (20) therebetween, comprising a housing (26) with a holding arrangement (22) for a workpiece (14) to be processed and a support arrangement (24) therefor, which comprises a plurality of pins (36) received in a chamber (34) provided in the housing (26), which for at least a major part are separately longitudinally displaceable and which are selectively fixable against longitudinal displacement with respect to the housing (26) by a clamping mechanism (42) and by their pin ends (38) serve the purpose of firmly supporting the workpiece (14), which is held by one of its workpiece surfaces (16, 18) at the retainer (10) by way of the holding arrangement (22), over an area at the workpiece surface (16, 18) facing the pin ends (38) in accordance with the geometry of the surface, wherein mounted on the housing (26) of the retainer (10) is the elastic membrane (12) according to any one of the preceding claims, which together with the housing (26) bounds the chamber (34), and wherein the perforation (44) as a component of the holding arrangement (22) is formed in the retaining section (30) of the membrane so that a vacuum applied to the chamber (34) is present by way of the perforation (44) on the outer side (32) of the retaining section (30) for holding the workpiece (14).
